(19) United States
(12) Patent Application Publication
(10) Pub. No.: US 2026/0097754 A1
(43) Pub. Date: Apr. 9, 2026

(54) CONTROL DEVICE FOR VEHICLE

(71) Applicant: TOYOTA JIDOSHA KABUSHIKI KAISHA, Toyota-shi (JP)

(72) Inventor: Toshio INOUE, Gotemba-shi (JP)

(73) Assignee: TOYOTA JIDOSHA KABUSHIKI KAISHA, Toyota-shi (JP)

(21) Appl. No.: 19/233,033

(22) Filed: Jun. 10, 2025

(30) Foreign Application Priority Data
Oct. 3, 2024 (JP) 2024-174212

(51) Int. Cl. B60W 20/16; B60W 10/06; B60W 10/08

(52) U.S. Cl. CPC B60W 20/16; B60W 10/06; B60W 10/08; B60W 2510/0676; B60W 2530/12; B60W 2540/103; B60W 2710/0627; B60W 2710/0666; B60W 2710/083

(57) ABSTRACT

An electronic control unit for controlling a vehicle equipped with an internal combustion engine in which two catalytic devices, namely an upstream catalytic device and a downstream catalytic device, are installed in an exhaust passage includes a processing circuit. The processing circuit performs a process of easing an execution condition for a fuel cut of the internal combustion engine when a condition for desorbing sulfur accumulated on the upstream catalytic device is satisfied and the downstream catalytic device is inactive.

### CROSS-REFERENCE TO RELATED APPLICATION

This application claims priority to Japanese Patent Application No. 2024-174212 filed on Oct. 3, 2024. The disclosure of the above-identified application, including the specification, drawings, and claims, is incorporated by reference herein in its entirety.

### BACKGROUND

### 1. Technical Field

The present disclosure relates to control devices for vehicles.

### 2. Description of Related Art

A catalytic device carrying a catalytic noble metal is known as an exhaust gas control device for an internal combustion engine such as an in-vehicle exhaust gas control device. In such a catalytic device, sulfur components in exhaust gas can cover the surface of the catalytic noble metal. This may lead to sulfur poisoning, reducing the exhaust control efficiency. A control device for an internal combustion engine described in Japanese Unexamined Patent Application Publication No. 2012-117458 (JP 2012-117458 A) performs sulfur poisoning recovery control. In the sulfur poisoning recovery control, when the temperature of a catalytic device is high, the control device executes a fuel cut to supply oxygen to the catalytic device. Sulfur components that have poisoned a catalytic noble metal are thus oxidized and released.

### SUMMARY

There is an internal combustion engine including two catalytic devices, namely an upstream catalytic device and a downstream catalytic device. In such an internal combustion engine, even when the exhaust control rate of the upstream catalytic device decreases due to sulfur poisoning, the downstream catalytic device still controls exhaust gas. Therefore, an increase in tailpipe emissions can be reduced. However, when sulfur poisoning of the upstream catalytic device occurs while the downstream catalytic device is still not warmed up, an increase in tailpipe emissions cannot be sufficiently reduced.

A control device for a vehicle according to the present disclosure is a control device for a vehicle equipped with an internal combustion engine including an upstream catalytic device installed in an exhaust passage and a downstream catalytic device installed in the exhaust passage at a position downstream of the upstream catalytic device. The control device includes a processing circuit.

The processing circuit is configured to perform a process of changing the content of control on the vehicle so as to promote execution of a fuel cut of the internal combustion engine when a condition for desorbing sulfur accumulated on the upstream catalytic device is satisfied and the downstream catalytic device is inactive.

The control device for the vehicle can reduce an increase in tailpipe emissions due to sulfur poisoning of the catalytic device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a first embodiment of a control device for a vehicle;

FIG. 2 is a flowchart of a process for promoting execution of poisoning recovery control executed by the control device of FIG. 1; and

FIG. 3 is a flowchart of an execution promotion process of poisoning recovery control executed by the vehicle control device according to a second embodiment.

### DETAILED DESCRIPTION OF EMBODIMENTS

### First Embodiment

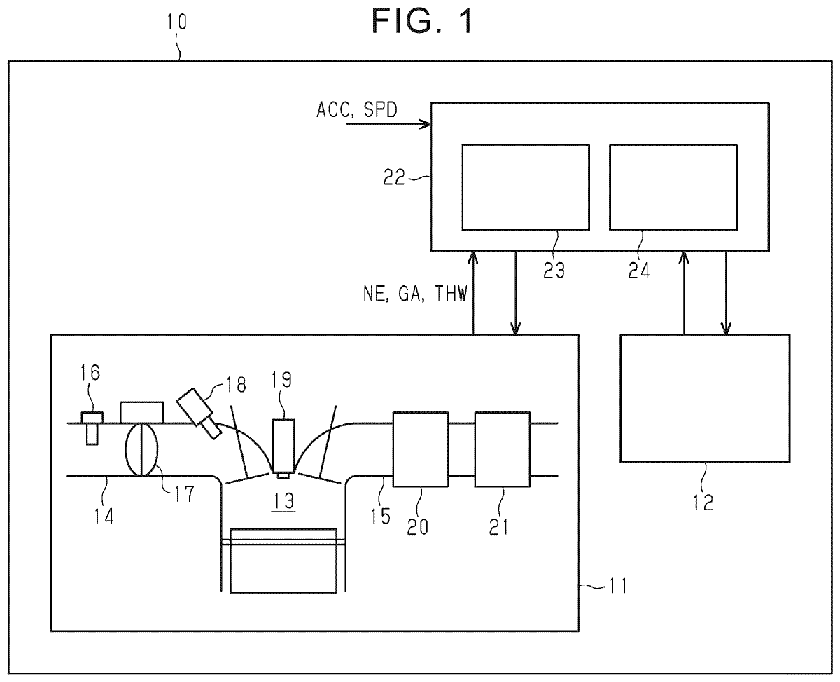

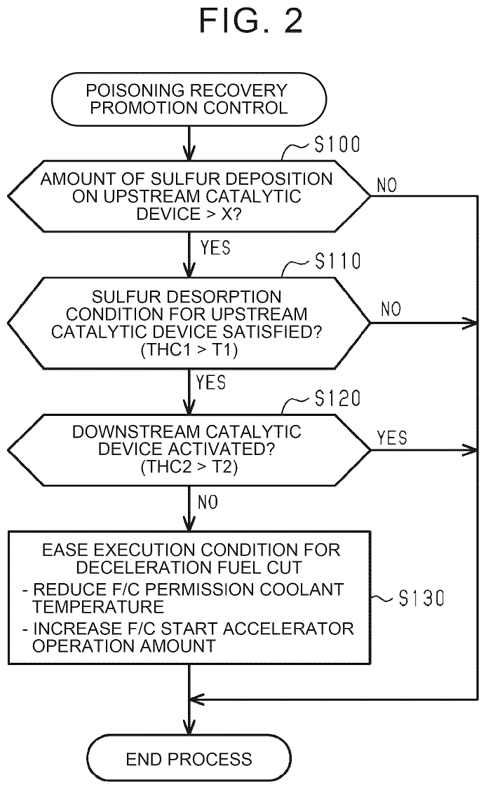

Hereinafter, a first embodiment of a control device for a vehicle will be described in detail with reference to FIGS. 1 and 2.

### Configuration of Vehicle Control Device

First, a configuration of a control device for a vehicle according to the present embodiment will be described with reference to FIG. 1. As shown in FIG. 1, the vehicle 10 is configured as a hybrid electric vehicle in which an internal combustion engine 11 and an electric motor 12 are mounted as a driving source for generating driving force for traveling.

The internal combustion engine 11 includes a combustion chamber 13 that performs combustion, an intake passage 14 that is a path for introducing air into the combustion chamber 13, and an exhaust passage 15 that is a path for discharging exhaust gas from the combustion chamber 13. The internal combustion engine 11 includes an air flow meter 16 that detects the intake air amount GA, and a throttle valve 17 that adjusts the intake air amount GA. The internal combustion engine 11 includes an injector 18 that injects fuel into the air flowing into the combustion chamber 13, and an ignition device 19 that ignites the air-fuel mixture introduced into the combustion chamber 13 by spark discharge. Furthermore, an upstream catalytic device 20 is installed in the exhaust passage 15 of the internal combustion engine 11. A downstream catalytic device 21 is installed in the exhaust passage 15 at a position downstream of the upstream catalytic device 20. The upstream catalytic device 20 and the downstream catalytic device 21 carry a catalytic noble metal, and have a function as a three-way catalytic device that simultaneously performs oxidation of hydrocarbons and carbon monoxide and reduction of nitrogen oxides to control exhaust gas. The upstream catalytic device 20 also functions as a filter device that collects particulate matter in the exhaust gas.

An electronic control unit 22 as a control device is mounted on the vehicle 10. The electronic control unit 22 includes a storage device 23 and a processing circuit 24. The storage device 23 stores a control program and data. The processing circuit 24 executes a program read from the storage device 23. The electronic control unit 22 acquires detection results of various sensors installed in each unit of the vehicle 10, such as the internal combustion engine 11. For example, the electronic control unit 22 acquires, in addition to the intake air amount GA detected by the air flow meter 16, the rotational speed NE and the coolant temperature THW of the internal combustion engine 11, the accelerator operation amount ACC, the vehicle speed SPD, and the like. The accelerator operation amount ACC represents a depression amount of the accelerator pedal of the driver. The electronic control unit 22 performs various kinds of control of the vehicle 10 based on the detection results.

### Sulfur Poisoning of Catalytic Device

In the upstream catalytic device 20 and the downstream catalytic device 21, sulfur poisoning that causes a decrease in the exhaust control rate may occur. Next, the mechanism of sulfur poisoning generation will be described. In the following description, the upstream catalytic device 20 and the downstream catalytic device 21 will be collectively referred to as a catalytic device.

The catalytic device includes a base material made of a porous material such as ceramics, a coating material applied to the surface of the base material, and a catalytic noble metal supported on the base material via the coating material. When the temperature of the catalytic device is lower than the predetermined temperature, the sulfur components (sulfur dioxide etc.) in the exhaust gas accumulates on the coating material. When the temperature of the catalytic device rises above the predetermined temperature and the inside of the catalytic device is in a rich atmosphere, the accumulated sulfur components are desorbed from the coating material. Then, sulfur in the desorbed sulfur components covers the surface of the catalytic noble metal, causing sulfur poisoning. In the following explanation, the lower limit of the temperature range of the catalytic device in which desorption of the sulfur components from the coating material occurs will be referred to as desorption start temperature T1. Note that the upstream catalytic device 20, which also functions as a filter device, has a lower exhaust control capability than the downstream catalytic device 21. Therefore, the upstream catalytic device 20 is more likely than the downstream catalytic device 21 to be in a state where the exhaust gas cannot be sufficiently controlled due to sulfur poisoning.

Incidentally, the fuel cut of the internal combustion engine 11 may be executed during deceleration of the vehicle 10. When the fuel cut is executed, since the exhaust gas flowing through the exhaust passage 15 is replaced with fresh air, oxygen is supplied to the upstream catalytic device 20. On the other hand, the sulfur adhering to the surface of the catalytic noble metal can be removed by combustion by being placed in an environment that has a high temperature and that is rich in oxygen. Therefore, the exhaust control rate of the upstream catalytic device 20, which has been reduced by the sulfur poisoning, can be recovered by the execution of the fuel cut.

### Poisoning Recovery Promotion Control

After the cold start of the internal combustion engine 11, the temperature of the upstream catalytic device 20 first enters a temperature range in which the sulfur components of the exhaust gas are accumulated on the coating material, and then reaches a temperature range in which the sulfur components are desorbed from the coating material and move to the surface of the catalytic noble metal. Therefore, after the cold start of the internal combustion engine 11, the exhaust control rate of the upstream catalytic device 20 tends to decrease due to sulfur poisoning. Even if the sulfur poisoning of the upstream catalytic device 20 has occurred, the exhaust gas can be controlled before being discharged into outside air as long as the downstream catalytic device 21 is active. Therefore, an increase in tailpipe emissions can be avoided. However, in a low-temperature environment, during traveling at high speeds, etc., a large amount of heat of the downstream catalytic device 21 is taken by outside air. This makes it difficult for the temperature of the downstream catalytic device 21 to rise. In such a case, since the upstream catalytic device 20 has been poisoned with sulfur and the downstream catalytic device 21 is inactive, both of them may not be able to sufficiently control the exhaust gas. The electronic control unit 22 executes poisoning recovery promotion control in order to reduce an increase in tailpipe emissions in such a situation.

FIG. 2 shows a routine of processing performed by the processing circuit 24 for the poisoning recovery promotion control. The processing circuit 24 repeatedly executes the routine at predetermined control cycles.

When this routine is started, the processing circuit 24 first determines in S100 whether the amount of sulfur deposition on the upstream catalytic device 20 is larger than a predetermined determination value X. When the processing circuit 24 determines that the amount of sulfur deposition exceeds the determination value X (YES), the process proceeds to S110. When the processing circuit 24 determines that the amount of sulfur deposition is equal to or less than the determination value X (NO), the process of this routine in the current control cycle ends. The amount of sulfur deposition represents the amount of sulfur components deposited on the coating material of the upstream catalytic device 20. The processing circuit 24 calculates an amount of increase or decrease in sulfur components deposited on the upstream catalytic device 20, based on the operating condition of the internal combustion engine 11 (for example, the intake air amount GA) and the upstream catalyst temperature THC1. Then, the processing circuit 24 calculates an estimated value of the sulfur deposition amount by accumulating the amount of increase or decrease. The upstream catalyst temperature THC1 represents the temperature of the upstream catalytic device 20. The processing circuit 24 estimates the upstream catalyst temperature THC1 based on the operating conditions of the internal combustion engine 11 (for example, the intake air amount GA, the coolant temperature THW, and the ignition timing).

In S110, the processing circuit 24 determines whether the sulfur desorption condition for the upstream catalytic device 20 is satisfied. Then, the processing circuit 24 advances the processing to S120 when it is determined that the sulfur desorption condition is satisfied (YES). On the other hand, when it is determined that the sulfur desorption condition is not satisfied (NO), the process of this routine in the current control cycle is ended. When the sulfur desorption condition is satisfied, it indicates that the upstream catalytic device 20 is in a state in which desorption of the sulfur components accumulated on the coating material can occur. In the present embodiment, the processing circuit 24 determines that the sulfur desorption condition is satisfied when the upstream catalyst temperature THC1 exceeds the desorption start temperature T1.

In S120, the processing circuit 24 determines whether the downstream catalytic device 21 is activated. When it is determined that the downstream catalytic device 21 is activated (YES), the processing circuit 24 ends the processing of this routine in the current control cycle. On the other hand, when it is determined that the downstream catalytic device 21 is not activated (NO), the processing circuit 24 advances the processing to S130.

In the present embodiment, the processing circuit 24 determines that the downstream catalytic device 21 is activated because the downstream catalyst temperature THC2 exceeds the catalyst activation temperature T2. The downstream catalyst temperature THC2 represents the temperature of the downstream catalytic device 21. Like the upstream catalyst temperature THC1, the processing circuit 24 estimates the downstream catalyst temperature THC2 based on the operating conditions of the internal combustion engine 11 etc.

In S130, the processing circuit 24 cases the execution condition for a deceleration fuel cut. After S130, the processing circuit 24 terminates the processing of this routine in the current control cycle. In the present embodiment, the execution condition for a deceleration fuel cut is set to be satisfied at least when the coolant temperature THW of the internal combustion engine 11 is equal to or higher than F/C permission coolant temperature and the accelerator operation amount ACC is equal to or lower than F/C start accelerator operation amount. Then, in S130, the processing circuit 24 reduces the F/C permission coolant temperature to a lower temperature than normal, and increases the F/C start accelerator operation amount to an operation amount greater than normal, thereby easing the execution condition for a deceleration fuel cut.

### Operation of First Embodiment

In the poisoning recovery promotion control of FIG. 2, the processing circuit 24 eases the execution condition for a deceleration fuel cut when all of the following requirements A to C are satisfied (S130). Requirement A is a requirement that the amount of sulfur deposition on the upstream catalytic device 20 is equal to or greater than the determination value X (S100: YES). The requirement B is a requirement that the -sulfur desorption condition for the upstream catalytic device 20 is satisfied (S110: YES). The requirement C is a requirement that the downstream catalytic device 21 is inactive (S120: NO). When both the requirements A, B are satisfied, it is considered that there is a high possibility that the upstream catalytic device 20 is in a state in which the exhaust control rate is lowered due to sulfur poisoning. When the requirement C is satisfied, the downstream catalytic device 21 cannot sufficiently control the exhaust gas. Therefore, when all of the requirements A to C are satisfied, the exhaust gas cannot be sufficiently controlled by the upstream catalytic device 20 and the downstream catalytic device 21, and thus tailpipe emissions may increase.

When the execution condition is eased, it is easy to obtain an opportunity to execute a deceleration fuel cut. In this way, the processing circuit 24 changes the content of control on the vehicle 10 so as to promote execution of a fuel cut of the internal combustion engine 11 by easing the execution condition. When a deceleration fuel cut is executed, the decrease in the exhaust control rate of the upstream catalytic device 20 due to the sulfur poisoning is eliminated. Therefore, an increase in tailpipe emissions is highly likely to be eliminated in a shorter period of time by easing the execution condition.

### Effects of First Embodiment

The control device of the vehicle 10 of the present embodiment has the following effects.
(1) Since the sulfur poisoning of the upstream catalytic device 20 is easily eliminated at an early stage, an increase in tailpipe emissions can be reduced.
(2) When the execution condition for a deceleration fuel cut is cased, the fuel cut is executed even in a situation where the fuel cut is not supposed to be executed, and there is a possibility that an adverse effect such as a delay in warm-up of the internal combustion engine 11 may occur. On the other hand, even when sulfur poisoning of the upstream catalytic device 20 occurs, tailpipe emissions will not increase as long as the downstream catalytic device 21 is sufficiently active. Even when the sulfur desorption condition for the upstream catalytic device 20 is satisfied, the processing circuit 24 cases the execution condition for a deceleration fuel cut only when the downstream catalytic device 21 is inactive. Therefore, it is possible to prevent the fuel cut from being unnecessarily executed in an inappropriate situation.
(3) The processing circuit 24 is configured to execute a deceleration fuel cut on a condition that the coolant temperature THW is equal to or higher than a predetermined temperature (F/C permission coolant temperature). On the other hand, the sulfur poisoning of the upstream catalytic device 20 is likely to occur in a situation where the coolant temperature THW after the cold start of the internal combustion engine 11 is not sufficiently increased. When the F/C permission coolant temperature is not changed, the fuel cut is not performed until the coolant temperature THW is sufficiently increased, so that the condition in which the exhaust control rate of the upstream catalytic device 20 is lowered may continue for a long time. On the other hand, the processing circuit 24 is configured to change the F/C permission coolant temperature to a lower temperature than normal in the process of casing the execution condition for a deceleration fuel cut. Therefore, an increase in tailpipe emissions due to sulfur poisoning of the upstream catalytic device 20 can be easily eliminated at an early stage.
(4) The processing circuit 24 is configured to execute a deceleration fuel cut on a condition that the accelerator operation amount ACC is less than a predetermined operation amount (F/C start operation amount). The processing circuit 24 is also configured to change the F/C start operation amount to a value larger than a normal value in the process of casing the execution condition for a deceleration fuel cut. When the F/C start operation amount is increased when the driver releases the accelerator pedal to decelerate the vehicle 10, a deceleration fuel cut is started at an earlier time than when the F/C start operation amount is not increased. As a result, since the fuel cut is continued for a longer time than usual, the sulfur poisoning of the upstream catalytic device 20 is easily eliminated with a small number of fuel cuts.

### Second Embodiment

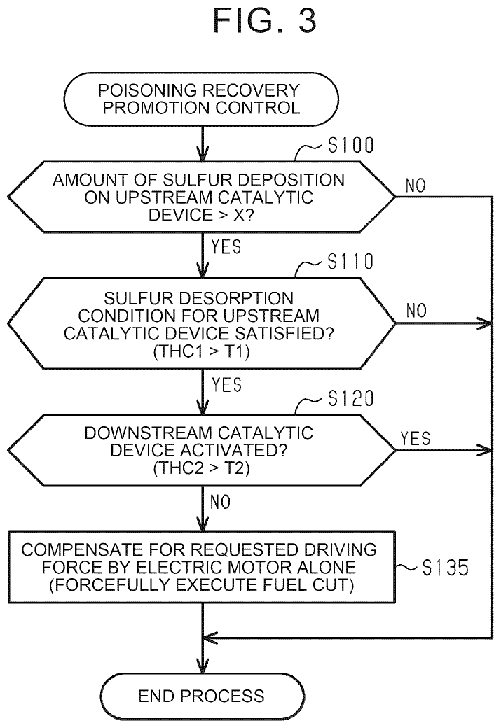

Next, a second embodiment of a vehicle control device will be described in detail with reference to FIG. 3. In the embodiment, constituents in common with the above embodiment are denoted by identical reference characters, and detailed descriptions for the constituents are omitted. The present embodiment and the first embodiment have the same configuration except for the processing content of the poisoning recovery promotion control.

In the hybrid electric vehicle 10, the processing circuit 24 calculates the requested driving force based on, for example, the accelerator operation amount ACC and the vehicle speed SPD. The requested driving force represents a driving force of the vehicle 10 requested by the driver through depression of the accelerator pedal. The processing circuit 24 determines the output distribution between the internal combustion engine 11 and the electric motor 12 such that the internal combustion engine 11 and the electric motor 12 together generate the driving force for the vehicle 10 corresponding to the requested driving force.

FIG. 3 shows a routine of processing performed by the processing circuit 24 for the poisoning recovery promotion control in the case of the present embodiment. The processing circuit 24 repeatedly executes the routine at predetermined control cycles. Note that S120 from S100 of FIG. 3 is the same process as in FIG. 2. In the case of FIG. 3, the processing circuit 24 advances the processing to S135 when a negative determination is made in S120 (NO). In this S135, the processing circuit 24 forcefully executes the fuel cut of the internal combustion engine 11 by compensating for the requested driving force by the electric motor 12. That is, in S135, the processing circuit 24 performs processing of changing the output distribution of the internal combustion engine 11 and the electric motor 12 so that the driving force corresponding to the requested driving force is generated only by the electric motor 12. As a result, the internal combustion engine 11 does not need to generate a driving force, so that the fuel cut of the internal combustion engine 11 can be executed regardless of whether the execution condition for a deceleration fuel cut is satisfied.

In the present embodiment configured as described above, in a case where the sulfur poisoning of the upstream catalytic device 20 occurs in a state in which the downstream catalytic device 21 is inactive, the fuel cut of the internal combustion engine 11 is forcibly executed. Therefore, the control device of the present embodiment can also reduce an increase in tailpipe emissions.

### OTHER EMBODIMENTS

The above embodiment can be modified and implemented as follows. The present embodiment and modification examples described below may be combined as desired as long as no technical inconsistency arises.
The upstream catalyst temperature THC1 and the downstream catalyst temperature THC2 may be estimated differently from the embodiments described above. A temperature sensor may be installed in the upstream catalytic device 20 and the downstream catalytic device 21 to actually measure the upstream catalyst temperature THC1 and the downstream catalyst temperature THC2.
In S110 of FIGS. 2 and 3, whether the sulfur desorption condition is satisfied may be determined in a manner different from that in the above embodiment. For example, in addition to the upstream catalyst temperature THC1, S110 may be determined based on the operating conditions of the internal combustion engine 11 such as the air-fuel ratio.
In S120 of FIGS. 2 and 3, it may be determined whether the downstream catalytic device 21 is activated in a manner that differs from the above-described embodiment. For example, it may be determined whether the downstream catalytic device 21 is activated based on the elapsed time after the start of the internal combustion engine 11, the cumulative air amount, and the cumulative fuel injection amount.
In S130 shown in FIG. 2, the execution condition for a deceleration fuel cut may be eased in a manner different from that in the above embodiment. For example, the execution condition may be eased by changing thresholds for the rotational speed NE of the internal combustion engine 11 and the vehicle speed SPD among the requirements constituting the execution condition.

### APPENDICES

The control device of the first embodiment can be similarly applied to a non-hybrid vehicle that is not equipped with the electric motor 12.

### Appendix 1

A control device for a vehicle equipped with an internal combustion engine including an upstream catalytic device installed in an exhaust passage and a downstream catalytic device installed in the exhaust passage at a position downstream of the upstream catalytic device includes a processing circuit. The processing circuit is configured to perform a process of easing an execution condition for a fuel cut of the internal combustion engine when a condition for desorbing sulfur accumulated on the upstream catalytic device is satisfied and the downstream catalytic device is inactive.

### Appendix 2

A control device for a vehicle equipped with an internal combustion engine and an electric motor includes a processing circuit. The internal combustion engine includes an upstream catalytic device installed in an exhaust passage, and a downstream catalytic device installed in the exhaust passage at a position downstream of the upstream catalytic device. The vehicle is configured such that the internal combustion engine and the electric motor together generate a driving force for the vehicle. The processing circuit is configured to perform a process of changing an output distribution between the internal combustion engine and the electric motor such that only the electric motor generates the driving force, when a condition for desorbing sulfur accumulated on the upstream catalytic device is satisfied and the downstream catalytic device is inactive.

What is claimed is:

1. A control device for a vehicle equipped with an internal combustion engine including an upstream catalytic device installed in an exhaust passage and a downstream catalytic device installed in the exhaust passage at a position downstream of the upstream catalytic device, the control device comprising a processing circuit,
wherein the processing circuit is configured to perform a process of changing content of control on the vehicle so as to promote execution of a fuel cut of the internal combustion engine when a condition for desorbing sulfur accumulated on the upstream catalytic device is satisfied and the downstream catalytic device is inactive.

2. The control device according to claim 1, wherein the process is a process of easing an execution condition for the fuel cut of the internal combustion engine.

3. The control device according to claim 2, wherein:
the internal combustion engine is configured to execute the fuel cut on a condition that a coolant temperature of the internal combustion engine is equal to or higher than a predetermined temperature; and
the processing circuit is configured to change the predetermined temperature to a low temperature in the process of easing the execution condition.

4. The control device according to claim 2, wherein:
the internal combustion engine is configured to execute the fuel cut on a condition that an accelerator operation amount is equal to or less than a predetermined operation amount; and
the processing circuit is configured to change the predetermined operation amount to a large value in the process of easing the execution condition.

5. The control device according to claim 1, wherein the vehicle is configured such that the internal combustion engine and an electric motor together generate a driving force for the vehicle, and the process is a process of changing an output distribution between the internal combustion engine and the electric motor such that the electric motor generates the driving force.
